(19) United States
(12) Patent Application Publication
(10) Pub. No.: US 2004/0208376 A1
(43) Pub. Date: Oct. 21, 2004

(54) Pattern recognition device and method

(75) Inventors: Bingxue Shi, Hsinchu (TW); Guoxing Li, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Winbond Electronics Corp.

(21) Appl. No.: 10/418,137

(22) Filed: Apr. 18, 2003

(51) Int. Cl. G06K 9/68

(52) U.S. Cl. 382/218

(57) ABSTRACT

A pattern recognition device for processing an array containing image data includes a first feature matching device, a first data compressor, and a second feature matching device. The first feature matching device matches the image data with a first feature module to generate feature information. The first feature module comprises a first set of categorizing features and the feature information identifies at least one matching categorizing feature. The first data compressor compresses the feature information to generate a feature chart for the array. The second feature matching device receives feature data created based on the feature chart and matches the feature data with a second feature module to generate a matching result. The second feature module comprises a second set of features that are provided based on the feature data.

### DESCRIPTION OF THE INVENTION

1. Field of the Invention

This invention pertains in general to pattern recognition, and, more particularly, to a pattern recognition device and a method for processing an image data array for pattern recognition.

2. Background

Signal processing devices implemented in the form of neural networks provide new applications, including those in recognizing various image or sound patterns. Compared to the conventional design for signal processing devices or computing devices, neural networks provide increased speed and improved robustness and make the processing devices less vulnerable to component failures. But most neural networks are designed for software implementations instead of integrated circuit implementations. Software implementations generally impose more limitations on the scale and capabilities of neural networks and are less favorable for implementing large-scale neural networks.

Modern very-large-scale-integration (VLSI) technology provides large scale processing circuits and has become one of the desirable technologies for implementing neural networks. Among various designs of neural networks, hamming neural networks are one of the designs that are suitable for VLSI implementations. Although current designs allow VLSI chips to implement various hamming neural networks, these chips have not delivered desirable processing speeds in some applications.

Among other functions, a hamming network can be configured to conduct recognitions of image, voice, and speech patterns. Image recognitions encompass various applications, such as handwriting recognitions, identification of similar images, pictures, graphics, or documents, and identification of persons for security or other purposes. Currently available implementations of pattern recognitions with hamming networks, however, usually involve complicated designs. The complexities and difficulties in the design considerably limit the availability and functionality of neural networks for pattern recognition applications.

### SUMMARY OF THE INVENTION

Accordingly, the present invention is directed to a pattern recognition device and a pattern recognition method that obviate one or more of the problems due to limitations and disadvantages of the related art.

Additional features of embodiments consistent with the invention will be set forth in the description which follows, and in part will be apparent from the description, or may be learned by practice of the invention. The advantages of embodiments consistent with the invention may be realized and attained by the device and method of the present invention particularly pointed out in the written description and claims thereof, as well as the appended drawings.

One aspect of the invention relates a pattern recognition device for processing an array containing image data. The device includes a first feature matching device, a first data compressor, and a second feature matching device. The first feature matching device matches the image data with a first feature module to generate feature information. The first feature module comprises a first set of categorizing features and the feature information identifies at least one matching categorizing feature. The first data compressor compresses the feature information to generate a feature chart for the array. The second feature matching device receives feature data created based on the feature chart and matches the feature data with a second feature module to generate a matching result. The second feature module comprises a second set of features that are provided based on the feature data.

Another aspect of the invention relates to a feature matching device for generating matching information by matching image data to a set of features. The device includes a matching rate computation circuit and a matching rate comparison circuit. The matching rate computation circuit computes a matching rate between the image data and each feature of the set of features by generating a matching current for each feature. The matching rate computation circuit then generates a plurality of matching currents. In the circuit, a sub-circuit for matching the image data to a feature comprises a current mirror that contributes to a matching current. In response to the results of the matching rate computation circuit, the matching rate comparison circuit compares the plurality of matching currents to identify the greatest matching current of the plurality of matching currents.

Another aspect of the invention relates to a method of processing an array of image data for pattern recognition. The method comprises: providing a first feature module containing a first set of categorizing features; matching the image data with the first feature module to generate feature information, wherein the feature information identifies a matching categorizing feature; compressing the feature information to generate a feature chart for the array; providing a second feature module containing a second set of modules provided based a feature data created based on the feature chart; and matching the feature data with the second feature module to generate a matching result.

Another aspect of the invention relates to a pattern recognition method. The method comprises: providing an array of image data for a pattern recognition; providing a first feature module containing a first set of categorizing features; matching the image data with the first feature module to generate feature information, wherein the feature information identifies a matching categorizing feature; compressing the feature information to generate a feature chart for the array; compressing the feature chart to generate feature data for the array; providing a second feature module containing a second set of modules provided based the feature data; and matching the feature data with the second feature module to generate a matching result.

Another aspect of the invention relates to a computer-readable medium that comprises instructions to cause a computer to execute the steps of: providing a first feature module containing a first set of categorizing features; matching the image data with the first feature module to generate feature information, wherein the feature information identifies a matching categorizing feature; compressing the feature information to generate a feature chart for the array; providing a second feature module containing a second set of modules provided based a feature data created based on the feature chart; and matching the feature data with the second feature module to generate a matching result.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention. In the drawings,

FIG. 1 shows a flow chart of a method for processing image data consistent with one embodiment of the present invention;

FIG. 2 shows an example of dividing an image data array into sub-arrays consistent with one embodiment of the present invention;

FIG. 3 shows a block diagram of a pattern recognition system consistent with one embodiment of the present invention;

FIG. 4 shows a circuit for implementing a first feature matching device consistent with one embodiment of the present invention;

FIG. 5 shows a graph illustrating the relationship between a matching current and a level of matching consistent with one embodiment of the present invention;

FIGS. 6A-6B show simulation results of a four terminal winner-take-all (WTA) circuit consistent with one embodiment of the present invention;

FIG. 7 shows a circuit for implementing a second data compressor consistent with one embodiment of the present invention; and

FIG. 8 shows a circuit for implementing a second feature matching device consistent with one embodiment of the present invention.

### DESCRIPTION OF THE EMBODIMENTS

Reference will now be made in detail to exemplary embodiments illustrated in the accompanying drawings. Wherever possible, the same reference numbers will be used throughout the drawings to refer to the same or like parts.

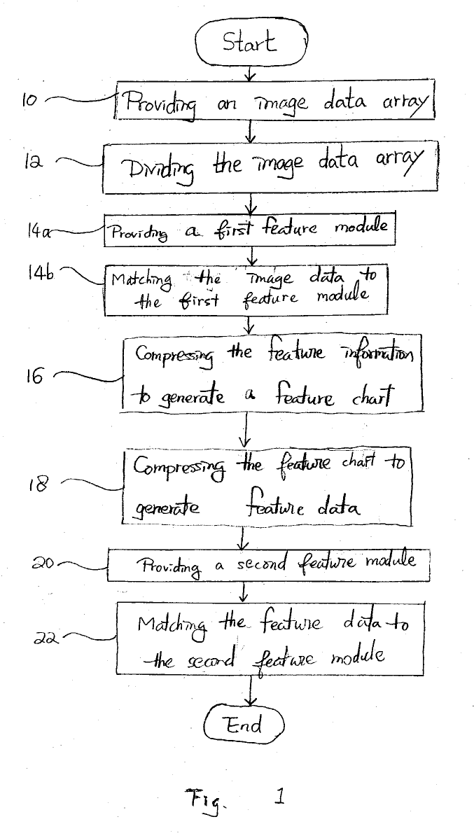

The present invention provides a method for processing image data for pattern recognition and a pattern recognition device. The method provides a two-level or multi-level matching process that first matches and categorizes image data and then conducts a second match or further matches based on such categorization. The method includes several of the steps illustrated in FIG. 1, such as providing an image data array for a pattern recognition, dividing the image data array into at least two sub-arrays, providing the first feature module, matching the image data with the first feature module, compressing the feature information to generate a feature chart, compressing the feature chart to generate a feature data, providing a second feature module, and matching the feature data to the second feature module. As the following paragraphs will illustrate, some of the steps in FIG. 1 are optional and are not necessary in some embodiments.

An image data array for pattern recognition is provided in step 10. As an example, the array includes image information, such as handwriting, a scanned image, a picture, a drawing, or a symbol, that is to be identified via a pattern recognition process. In one embodiment, the image data array contains at least a handwritten Chinese character, a number, or an English letter, or a portion of one of

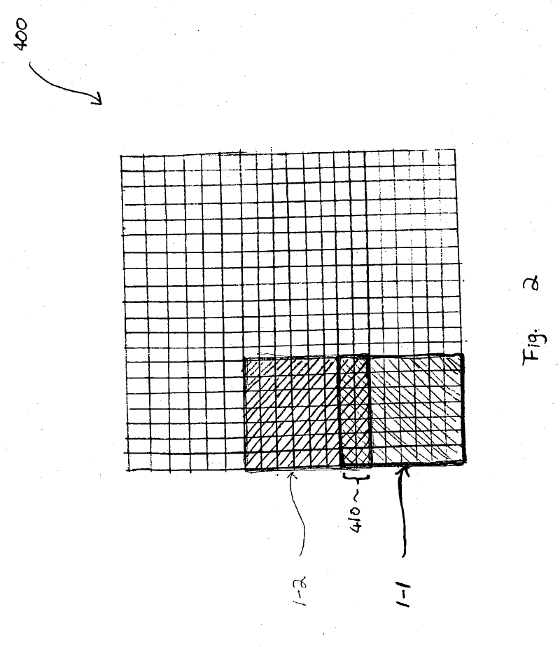

The size of an image data array varies depending on different processing capabilities. In one embodiment, the image data array consists of a 20-by-20-pixel area, namely a square image data array of 400 pixels. FIG. 2 provides an example of a 20×20 array, image data array 400. Image data array 400 contains a pattern that is to be identified or recognized with a pattern recognition process.

The image data array provided in step 10 is then be divided into two or more sub-arrays in step 12 in FIG. 1. If image data array is small in size and contains fewer pixels, the subdividing step is not necessary in some embodiments and the array is processed without subdivision. Under certain circumstances, dividing the array into sub-arrays allows efficient operation of the pattern recognition process. Also, subdivision becomes necessary in some embodiments. Examples of those embodiments include when the image data array is large in size and contains a large number of pixels and when the system processing capability is more limited.

In one embodiment, the sub-arrays divided from the array have an overlapping area or areas with neighboring sub-array or sub-arrays. The overlapping design allows each sub-array to encompass some pixels of one or more neighboring arrays. In some embodiments, the design avoids breaking certain features in the original array into two separate sub-arrays and making the features become unrecognizable pieces in the two sub-arrays.

As an example of dividing an array, array 400 in FIG. 2 is divided into 3×3 sub-arrays. In one embodiment, each sub-array has an 8-by-8-pixel area and has an overlapping area with each neighboring sub-array. The overlapping area at the interfering region of two sub-arrays has two pixels in width and eight pixels in length. For example, sub-array 1-1 and sub-array 1-2 in FIG. 2 have an overlapping area that is two pixels wide and eight pixels long. As noted above, the subdivision of an original array into sub-arrays is an optional step. In addition, the extent and manner of subdividing an image data array varies according to different system designs and requirements.

Referring to FIG. 1, after optional step 12, a first feature module is provided in step 14a. In one embodiment, the first feature module contains a set of categorizing features that are designed to help the identification of what category or categories of features or characters the image data belong to. In other words, when the image data inside a sub-array have a better match to one or more categorizing features than other categorizing features, a sub-array, or an image data array, can be characterized as having characters or images of one or more categories. In one embodiment, the first feature module is a binary value (digital) module that uses “0” and “1” to represent the pixel information for each pixel of each categorizing feature.

The recognition of a handwritten Chinese character provides an example of using the categorizing features. In one embodiment, the categorizing features in the first feature module include key portions of different Chinese characters that help to distinguish one category of characters from another category of characters. The categorizing features therefore help to identify the category or categories of character that a sub-array or an image data array has.

In an embodiment of recognizing Chinese characters, examples of categorizing features include crossed strokes, angled strokes, an end point of a stroke, a starting point of a stroke, a curved portion, and other key features of Chinese characters. Once image data in a sub-array are identified as having a better match with a certain categorizing feature or features, a sub-array or an image data array is characterized as having certain types of characters, such as certain radicles of some Chinese characters or certain types of Chinese characters, Arabic numbers, or English letters. In one embodiment, the first feature module includes twenty-three (23) categorizing features.

With the first feature module provided, the image data of a sub-array are matched to the first feature module in step 14b. The image data are matched with each of the categorizing features to generate feature information for each sub-array. As discussed above, a categorizing feature, if having a better match with an image data, helps to identify the category or categories of characters that a sub-array or an image data array has. Therefore, each of the categorizing features and the image data of a sub-array is matched to identify the best matching feature or features. The matching step 14b therefore identifies one or more matching categorizing features in the feature information generated.

In one embodiment, matching step 14b is performed with two or more scanning windows that are smaller in size than a sub-array. The use of scanning windows simplifies the matching operation in step 14b by providing a less number of pixels being processed at one time. In some embodiments, a smaller scanning and comparing area for matching to features reduces system requirements and the demand on signal processing capabilities. Accordingly, the approach makes the pattern recognition process more manageable and/or allows a more cost-effective system design.

The size of the scanning windows is selected based on several factors, such as the signal processing capabilities of a system, the adequate scanning window size to identify most categorizing features, the size of a sub-array or an image data array, and the design of a pattern recognition circuit or network. In one embodiment, scanning windows of 5×5 pixels are used. Each sub-array, therefore, is scanned with multiple 5×5 scanning windows. And the image data from each of the scanning windows are compared with the categorizing features in the first module to generate feature information for each scanning window.

As discussed above, the feature information identifies at least one matching feature. In one embodiment, the feature information for each scanning window identifies the two or more most-matched categorizing features. Identifying the two most matched features for each scanning window has proven to improve a correct recognition rate in one embodiment of recognizing handwritten Chinese characters. In the embodiment of using 8-×-8-pixel sub-arrays, each sub-array is scanned with 5×5 scanning windows, and each scanning window is provided with the two most matched features. Therefore, the feature information of each sub-array identifies 23 categorizing features in this embodiment.

In addition, the concept of using a matching adjustment factor can be incorporated in matching step 14b in one embodiment. The concept embodies adjusting the matching results by compensating for the difficulties in matching images to different features. The concept provides matching adjustment factors for some or all of the categorizing features in order to reflect and compensate for the difficulties in matching images to respective categorizing features.

In one embodiment, a matching adjustment factor includes a threshold value created based on the level of difficulty in matching images to a particular categorizing feature. The threshold value is provided in the form of adding a value, such as an electric current, to the result of matching an image to a particular feature. The added value decreases with the increased difficulty of matching. Accordingly, the matching result is compensated to provide a better indication of an actual matching level.

As an example, the categorizing features include crossed strokes, angled strokes, an end point of a stroke, a starting point of a stroke, curve, and other variations of a Chinese character in one example illustrated above. The difficulty of matching images to each of the features varies. Therefore, matching results to different features, if unadjusted, do not truly reflect the actual level of similarity between an image and a particular feature in some embodiments. Adding a threshold value to a matching result compensates for the matching difficulty or complexity in matching to a particular feature.

The concept of using a matching adjustment factor, as the example discussed, seeks to standardize the matching results across different features to provide more accurate indications of similarities. In another embodiment, the matching adjustment factor is a percentage value that directly increases or reduces matching results by a predetermined percentage for each feature.

To reduce the amount of data of the feature information generated by step 14b, it is compressed in step 16 to generate a feature chart. Referring to FIG. 1, the feature information is generated in matching step 14b for each scanning window or sub-array to identify one or more matching categorizing features. In an embodiment using 8-×-8-pixel sub-arrays and 5-×-5-pixel scanning windows, the feature information identifies 8 categorizing features. In some embodiments, one or more of those features are the same or similar, or related to the same or similar categories. Accordingly, some features are combined and the feature information of each sub-array is compressed to generate a feature chart for that sub-array.

In one embodiment, the feature information for each sub-array is compressed to provide only eight categorizing features via step 16. Each categorizing feature is represented by a feature vector. Therefore, seventy-two (72) feature vectors are provided after compression to represent the image data of the nine (3×3) sub-arrays discussed above. The compression reduces the amount of data, but still provides a feature chart representative of the image in the image data array.

After compressing step 16, step 18 is optionally performed to further compress the feature chart. In one embodiment, a self-relating method, a genetic algorithm, or both, are applied to further compress the seventy-two (72) vector feature chart to a forty-eight (48) vector feature data.

After the optional compressing step 18, a second feature module is provided in step 20. The second feature module contains a second set of features that are provided as templates for matching and generating final matching results. In one embodiment, the second set of features is provided based on the feature data, which contains compressed or uncompressed feature chart and identifies categorizing feature or features. In other words, the method provides a two-level matching, with the first level identifying categories of image data and the second level matching the image data to features in one or more selected categories. This approach allows a better-focused pattern matching within a category or categories during the second level matching than a single-level matching. In addition, it also provides improved efficiency and accuracy in some embodiments.

As an illustration, if a feature chart resulting from step 16 or a feature data resulting from step 18 discussed above identifies the category of Arabic numerals, the second feature module is provided with a module of ten (10) Arabic numerals, namely numbers of 0 to 9, as a part of the second set of features. In addition, based on the categorizing feature or features identified by the feature chart or the feature data, one or more sets of second feature module can be provided in step 20.

After at least one set of second feature module is provided in step 20, the feature data (from step 18), or alternatively the feature chart (from step 16), is matched with the second feature module (from step 20) to generate a matching result in step 22. As discussed above, the second match is a more focused matching within a category or categories. The two-level matching increases operational efficiency and improves matching accuracy in some embodiments. In step 22, the image data contained in the feature data or feature chart are compared to the features in the second feature module and the level of matching to each feature is identified. And the most matched feature or two or more most matched features are identified in the matching result.

Because specific features are provided in the second feature module for the matching, the matching result resulting from step 22 can represent a final matching result. The final matching result usually identifies one or more definite, pre-existing features, such as a Chinese character, an English character, an Arabic numeral, a predetermined image pattern, or a combination of characters or patterns. The final matching result, therefore, identifies the handwriting symbol contained in the image data array as representing a particular character or characters and the pattern recognition process is then completed. Depending on different applications, the matching results can also identify two or more features for another level of matching operation. Accordingly, a further matching operation or operations similar to the second matching discussed above is added to provide a multiple-level matching.

Furthermore, the matching process of step 20 uses an actual value module instead of a binary value module in one embodiment. An actual value module uses actual value (analog) or near-actual value information, rather than binary value (digital) information, to describe the pixels of each feature in the module. Such actual value representation better represents the features in the module and improves pattern recognition results in some applications.

The paragraphs above discussed the method of the invention and its various embodiments. In one embodiment, the method is implemented with an FINNEGAN integrated circuit chip or chips, such as a chip using the VLSI technology. Alternatively, the method is implemented with software, together with a processing or computing device, in another embodiment. As a result, a computer-readable medium is configured to contain instructions that cause a computer or a processor to execute the steps illustrated above. In addition, the instructions can be stored in an E²PROM (electrically erasable programmable read-only memory) to allow flexibilities of updating and altering various aspects of operations, such as instructions, feature data, and adjustment factors. The E²PROM is coupled with a processor and control the processor's operations based on the data stored in the E²PROM. Therefore, if the data in an E²PROM is outdated or unsuitable for particular applications, the data are updated or modified to fine-tune the matching operations to satisfy different requirements.

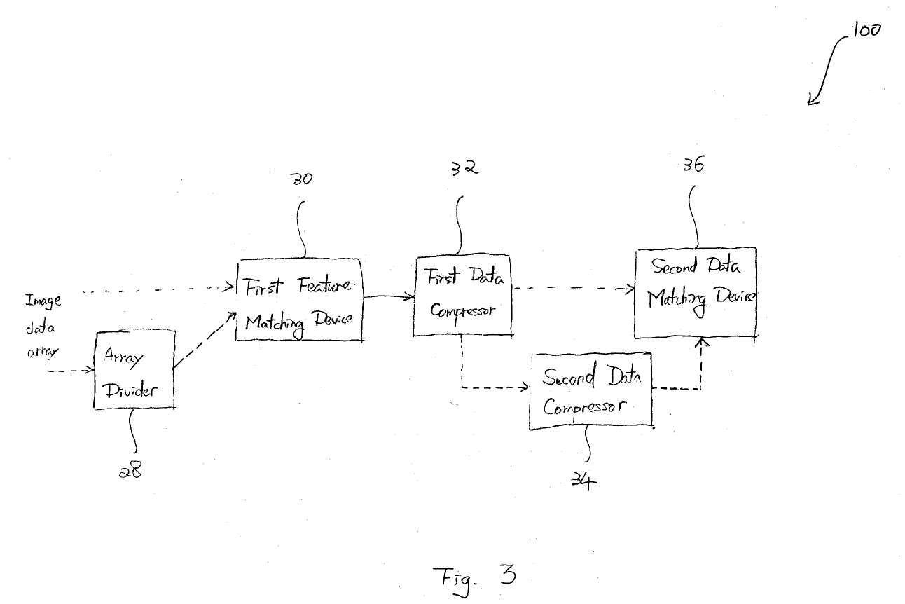

In addition to the method discussed above, the present invention also provides a pattern recognition device or system. The system of the present invention performs a two-level or multi-level matching that first matches and categorizes image data and then performs a second match or further matches based on the categorization in the previous level. Referring to FIG. 3, pattern recognition system 100 includes several devices, such as array divider 28, first feature matching device 30, first data compressor 32, second data compressor 34, and second feature matching device 36.

Array divider 28 is an optional device for system 100. It divides an image data array containing a to-be-recognized pattern or image data into two or more sub-arrays. As noted above, dividing the array into sub-arrays allows efficient operation of a pattern recognition device and process under certain circumstances, for example, when a system has limited signal-processing capabilities. Also, each of the sub-arrays divided from the image data array has an overlapping area or areas with a neighboring sub-array or sub-arrays in some embodiments to avoid breaking some features into unrecognizable pieces.

As illustrated above, exemplary array 400 of 20×20 pixels in FIG. 2 is divided into 3×3 sub-arrays in one embodiment. Each sub-array has an 8-by-8-pixel area, including an overlapping area of two pixels in width and eight pixels in length with each of the neighboring sub-arrays.

First feature matching device 30 operates to match the image data of each of the sub-arrays with a first feature module to generate feature information for each of the sub-arrays. If system 100 does not use array divider 28, first feature device 30 operates to match the undivided image data of the image data array directly with a first feature module and generate feature information for the entire image data array.

As discussed above, the first feature module contains a set of categorizing features that assist system 100 to identify what category or categories image data possibly belong to. Examples of the categorizing features are provided above. In one embodiment, the first feature module is a binary value (digital) module that uses “0” and “1” to represent the pixel information for each pixel of each categorizing feature. In one embodiment, the first feature module provides twenty-three (23) categorizing features.

Accordingly, first feature device 30 provides a categorizing function to categorize the image data of a sub-array or the entire array. As described above, the image data of a sub-array is characterized as having characters of a category or categories when it has better matches with a certain categorizing feature or features. Therefore, the feature information that first feature device 30 generates identifies at least one matching categorizing feature. Depending on the categorizing features provided and matched to, a sub-array is determined to have certain radicles of certain Chinese characters, or a portion of numbers or English letters, as discussed above.

In one embodiment, first feature matching device 30 provides a matching adjustment factor for each of the categorizing features in order to reflect and compensate for the difficulty in matching images to a particular categorizing feature. In one embodiment, a matching adjustment factor is a threshold value or an adjusting or compensating factor that is created based on the level of complexity or difficulty of matching images to a particular categorizing feature. By adding the matching adjustment factors, first feature matching device 30 generates adjusted or compensated results to better reflect the actual level of matching between image data and one or more categorizing features and provide more standardized, meaningful results in some cases.

In performing the matching, first feature device 30 uses two or more scanning windows that are smaller than a sub-array in one embodiment. First feature device 30 compares the image data in the scanning windows with the categorizing features. As noted above, reducing the size of image data to be compared in each matching makes the matching operation more manageable and/or allows a more cost-effective system design in some embodiments.

In one embodiment, first feature device 30 uses scanning windows similar to those discussed above for step 14b of the method in FIG. 1. Accordingly, the size of the scanning windows is selected based on several factors, such as the signal processing capabilities of a system, adequate sizes for identifying most categorizing features, the size of the sub-arrays and image data array, and the design of a pattern recognition system.

In one embodiment, first feature device 30 uses 5-by-5-pixel scanning windows. It therefore reads or scans the sub-arrays with multiple 5×5 scanning windows and compares the image data within each scanning window with the first module. It then generates feature information for each scanning window. In one embodiment, the feature information is generated by providing two most-matched categorizing features for each 5×5 scanning window. Because each sub-array is scanned with scanning windows and each scanning window is scanned to provide two most matched features, first feature device 30 provides each set of feature information with a list of 8 matching categorizing features.

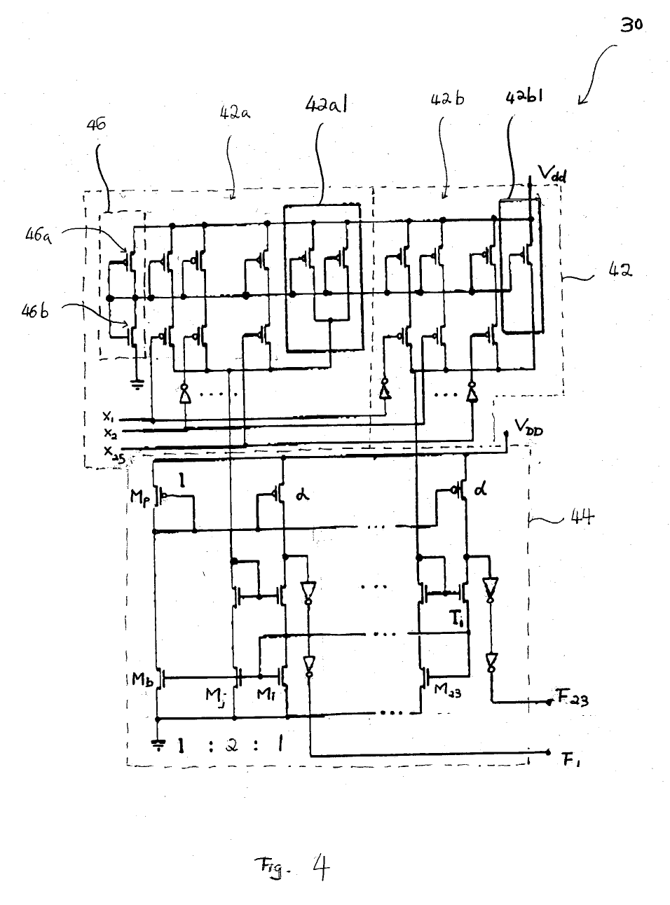

FIG. 4 illustrates the implementation of first feature matching device 30 with feature matching circuit. The feature matching circuit generates feature information by matching image data to a set of features. Implemented with a hamming network in one embodiment, it has a matching rate computation circuit 42 and a matching rate comparison circuit 44. In one embodiment, matching rate computation circuit 42 computes a matching rate between the image data and a set of features to generate a matching current for each feature. Matching rate comparison circuit 44 then compares matching currents to identify one or more most

In an embodiment using 5×5 scanning windows, matching rate computation circuit 42 receives twenty-five (25) pixel inputs, X₁ through X₂₅, that represent the image data of a 5-x-5-pixel scanning window. For the purpose of illustration, FIG. 4 shows only two exemplary sub-circuits, or “neurons” 42a and 42b, of a plurality of neurons. Each neuron includes a sub-circuit for comparing input image data with a categorizing feature. If circuit 42 stores twenty-three (23) categorizing features, it would include 23 neurons. For illustration, FIG. 4 shows only three exemplary inputs, X₁, X₂, and X₂₅, of the 25 inputs that each neuron receives in this embodiment. Also, each neuron stores one known categorizing feature or pattern and the weight or importance of each pixel or a particular feature by varying the gate lengths and widths of the transistors used in the neuron.

Neuron 42a and neuron 42b can use similar circuits, except for their input inverters and circuits for adding adjustment factors. The input inverters may identify whether a stored feature in one neuron has an “on” status for a particular pixel. As an example, a feature or pattern stored in a particular neuron exhibits some “on” pixels and other “off” pixels to represent a particular feature pattern. The insertion of an inverter signifies that the particular pixel for that feature is “on” in one embodiment. For example, in neuron 42a in FIG. 4, the feature it stores has an “on” status for a pixel corresponding to the pixel location input X₂ in one embodiment. Therefore, an inverter is inserted so that the presence of an “on” signal, which matches better with the corresponding “on” pixel of a feature, will result in increased current of the compared result when p-type metal oxide semiconductor (PMOS) Street, NW transistors are used to generate the matching currents as shown in FIG. 4.

In one embodiment, a neuron of matching rate computation circuit 42 includes a current mirror to adjust a matching current, which is generated from matching image data to a feature. For instance, first neuron 42a includes current mirror 42a1 that contributes directly to the matching current generated by first neuron 42a. By directly affecting the matching current, current mirror 42a1 serves as an adjustment mechanism for the matching performed by first neuron 42a. The current provided by a current mirror depends on the level of adjustment needed for matching to a particular feature. A current mirror provides a matching adjustment factor for each of the categorizing features to compensate for the difficulty in matching images to a particular categorizing feature.

In one embodiment, current mirror 42a1 includes two transistors in a parallel connection by their source and drain terminals, each having one of the source and drain terminals connecting to a voltage source Vdd and the other connecting a matching current output. Their gate terminals are connected to a bias output terminal of bias circuit 46.

Bias circuit 46 includes two transistors in a series connection in one embodiment to form a part of current mirror 42a1, and also a part of the current mirrors of other neurons. As shown in FIG. 4, first bias transistor 46a of bias transistor 46 has the first end of its source and drain terminals connected to a voltage source and has the second end connected to its gate and the bias terminal. Second bias transistor 46b of bias transistor 46 has the first end of its source and drain terminals connected to its gate and the bias terminal and has the second end connected to a ground terminal. As a part of the current mirrors of the neurons in matching rate computation circuit 42, bias circuit 46 may adjust the output currents of these current mirrors and thereby affecting the output current of each neuron.

As an alternative configuration of using two-transistors and bias circuit 46 for current mirror 42a1, a combination of a single transistor, such as transistor 42b1 for neuron 42b, and bias circuit 46, serves as a current mirror that contributes directly to the output current of neuron 42b. As shown in FIG. 4, transistor 42b1 has one of its source and drain terminals connecting to a voltage source Vdd and the other connecting to a matching current output. To allow output current control, the gate terminal of transistor 42b1 is connected to the bias terminal of bias circuit 46.

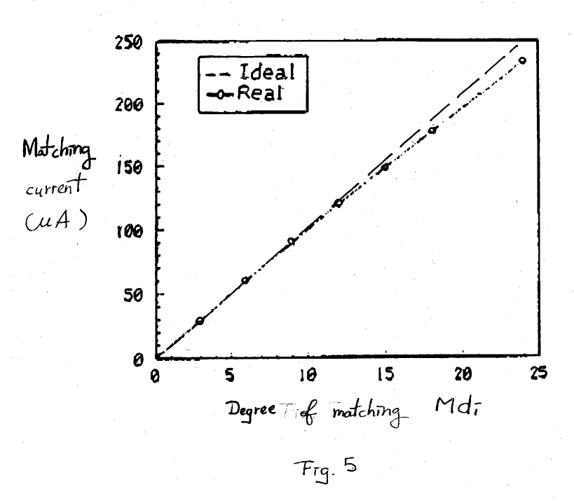

FIG. 5 shows a graph illustrating the relationship between a matching current and a level of matching image data to a feature in one embodiment of the present invention. The actual matching current and the level of matching or similarity have a near-linear relationship, having only a minor deviation of the actual matching current from the ideal linear relationship when the level of matching is higher. Such deviation is caused by the channel-length modulation effect of PMOS transistors in one embodiment. Indeed, when the input impedance of matching rate comparison circuit 44 described below is a constant, the voltage between the source and drain nodes of a PMOS transistor or transistors in a current mirror reduces with an increasing matching current. Because of the channel-length modulation effect, the current provided by the current mirror reduces with the reduced source-drain FINNEGAN voltage of the PMOS transistor. The reduced current from the current mirror therefore causes the matching current to drop slightly.

In one embodiment, the input impedance of matching rate comparison circuit 44, also known as a winner-take-all (WTA) circuit, is reduced to compensate for such deviation. Alternatively, the channel length of the PMOS transistors in a current mirror is increased to compensate for such deviation in another embodiment. In circuit design, factors such as the balance between the characteristics of a circuit and the area that the circuit occupies can affect whether adjustment should be made and how much adjustment should be made.

Referring to FIG. 4, matching rate comparison circuit 44 receives and compares a plurality of matching currents from matching rate computation circuit 42. It also identifies one or more greatest matching currents from the comparison. In one embodiment, each matching current represents the matching level or rate between the image data of a scanning window and a categorizing feature.

As an example, matching rate comparison circuit 44 is implemented by a k-WTA circuit that identifies k greatest matching rates among all of the matching rates. In one embodiment, matching rate comparison circuit 44 provides output to twenty-three (23) output terminals F₁ to F₂₃ with each terminal carrying a signal for the corresponding feature. When a particular feature is the best match, matching rate comparison circuit 44 generates a signal, in one embodiment a logic “low” or a lower voltage, at the corresponding output terminal while other output terminals have a logic “high” or higher voltages. In one embodiment, matching rate comparison FINNEGAN circuit 44 includes a two-WTA (2-WTA) circuit to identify two greatest (the greatest and the second greatest) matching currents. Therefore, two most-matched categorizing features are identified.

In one embodiment, matching rate comparison circuit 44 shown in FIG. 4 includes a maximum current comparator. The transistors for p-type-metal-oxide-semiconductor (“NMOS”) current mirrors, including transistors M_{b} and M₁ to M₂₃, constitute a differential circuit for comparing currents in one embodiment. The characteristics of these transistors significantly affect how matching rate comparison circuit 44 operates. Transistors a provide a factor that is less than 1 to adjust the input matching currents before being compared. For some applications, the 2-WTA circuit in FIG. 4 provides a simple structure, desirable accuracy, and a dynamic operational range ranging from weak inversion to strong inversion regions of transistor operations. Also, the circuit having an improved Wilson current mirror design provides the advantages of a Wilson current mirror design, but consumes less power than the conventional design. For example, a 2-WTA circuit having eleven input terminals consumes only 0.5 mW when the average input current is about or beyond 50 μA.

In particular, referring to FIG. 4, the relative width/length ratios of NMOS transistors Mb, Mj, and Mi are 1:2:1 in one embodiment, which determine the current ratios of these NMOS transistors. Due to strong positive feedbacks, matching rate comparison circuit 44 selects the maximum current. In addition, because the current of the Mj-branch current mirror is 2, a single maximum current does not provide sufficient balance of currents. As a result, matching rate comparison circuit 44 operates to select two maximum currents, namely the maximum current and the second maximum current. In other words, matching rate comparison circuit 44 operates as a 2-WTA circuit.

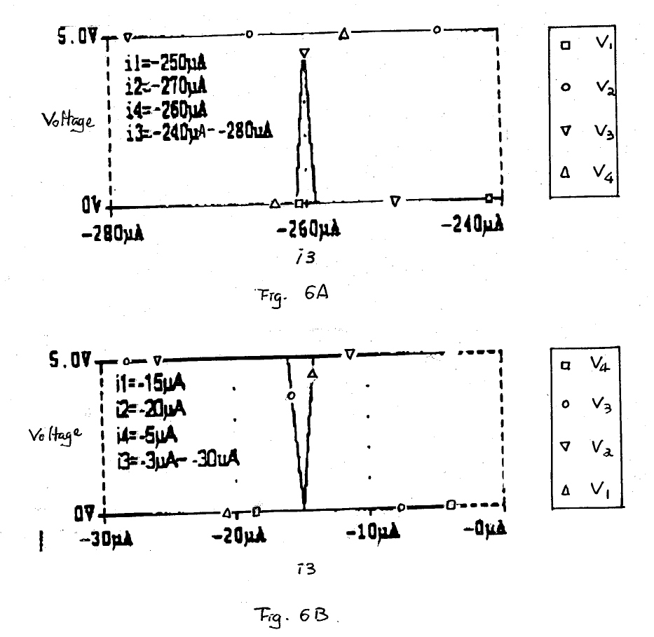

FIG. 6A illustrates the simulation results for a 2-WTA circuit with four input currents i1 to i4. The simulation allows i3 to vary while i1, i2, and i4 remain constant. Output signals V₁ to V₄ each corresponds to each of input currents i1 to i4. The horizontal axis shows the variation of i3 from −280 to −240 μA, and the vertical axis shows voltage levels. According to the simulation results, the circuit has a resolution of about 5 μA and distinguishes current inputs that have a difference of 5 μA and beyond. In particular, the maximum current is i2 (V₂) and the second maximum (negative) current is i4 (V₄), initially under the simulation. When i3 varies to exceed i4 (−260 μA) negatively, i3 becomes the second maximum current, causing V₃ to rise to a high level and V₄ to drop to a low level. As shown in FIG. 6A, the short transition demonstrates that the resolution is about 5 μA.

Similarly, FIG. 6B illustrates the simulation results for the same WTA circuit, but with input currents at much lower levels. The simulation varies i3 while keeping i1, i2, and i4 constant. Output signals V₁ to V₄ each corresponds to each of input currents i1 to i4. The horizontal axis shows the variation of i3 from −3 to −30 μA (shown negatively), and the vertical axis shows voltage levels. As shown, the circuit has a resolution of about 1 μA when operating with lower input currents and distinguishes current inputs that have a difference of 1 μA and beyond. In particular, the maximum (negative) current is i2 (V₂) and the second maximum is i1 (V₁), initially under the simulation. When i3 varies to exceed i1 (−15 μA) negatively, i3 becomes the second maximum current, causing V₃ to rise to a high level and V₁ to drop to a low level. As shown in FIG. 6B, the short transition demonstrates that the resolution is about 1 μA. In one embodiment, the resolution of the circuit is substantially proportional to the reciprocal of the square root of an operating current. The resolution also depends on the differences between input currents.

Referring to FIG. 3, the system of the invention also provides first data compressor 32 for receiving the feature information from first feature matching device 30 and compressing the feature information to generate a feature chart. If the image data array is divided into sub-arrays, a feature chart is generated for each sub-array. First data compressor 32 can apply various compressing methods or algorithms, depending on different needs and system designs.

In one embodiment, the image data for different sub-arrays are inputted sequentially and two most matching categorizing features are identified for each scanning window. Accordingly, the feature information of a sub-array is provided a plurality of categorizing features, such as K features, from all of the feature information of the scanning windows in one sub-array. Some of these categorizing features are related to the same or similar categories and therefore can be combined. As an example, first data compressor 32 receives the feature information of a sub-array, compresses or combines the same or similar categorizing features, and reduces the number of categorizing features to M (M<K). The M features form a feature chart that is still representative of the feature information for the sub-array.

As an example, for an 8-×-8-pixel sub-array using 5-×-5-pixel scanning windows, the feature information includes 23 categorizing features. In one embodiment, first data compressor 32 compresses the feature information to generate a feature chart of eight categorizing features for a sub-array, with each categorizing feature represented by a feature vector. With nine (3×3) sub-arrays in the image data array as discussed above, seventy-two (72) feature vectors are generated. First data compressor 32 therefore produces a feature chart for each sub-array that has a shorter data length than the pre-compression feature information, but is still representative of the image in each sub-array.

Second data compressor 34 shown in FIG. 3 is an optional device for the system to further compress the feature chart generated by first data compressor 32. In one embodiment, the seventy-two-vector feature chart contains too much information for conducting a second feature matching. Second data compressor 34 therefore further compresses the feature chart. The compression reduces the complexity and scale of the circuits necessary for conducting the second feature matching. In addition, the second data compressor is also configured to correct possible partial distortions of some of the features in one embodiment.

In one embodiment, second data compressor 34 employs a control circuit to compress the feature chart on an area-by-area basis according to a predetermined division. With the sequential input of data, second data compressor 34 provides a streamline operation to compress the feature chart.

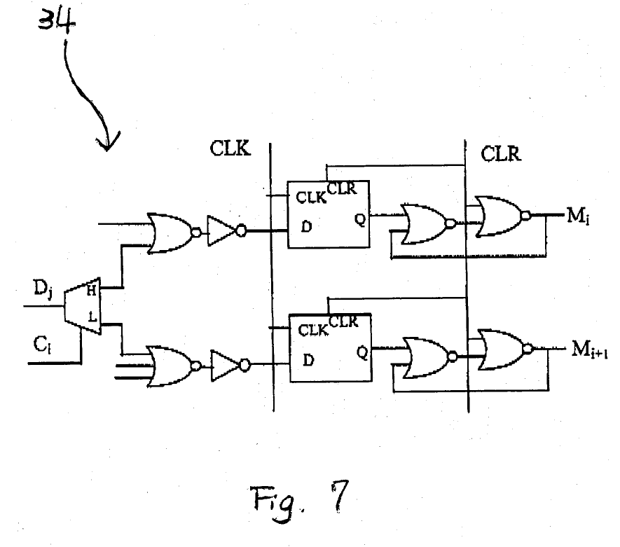

FIG. 7 shows a circuit for implementing second data compressor 34 in one embodiment. Second data compressor 34 combines the information relating to the same or similar features together and accomplishes compression of data by identifying whether a specific feature exists in a particular area. To operate the circuit in FIG. 7, Dj (j=1, 2, . . . , 24) come from a WTA circuit, each digit representing a feature, and Ci (l=1, 2, . . . , 10) represent allocation codes for combining features. If Ci becomes a logic high, the j-th feature is combined with the i-th feature. If Ci becomes a logic low, the j-th feature is combined with the (i+1)-th feature. Allocation codes Ci (l=1, 2, . . . , 10) may be prescribed to facilitate assembling similar features according to the characteristics of features and other considerations. As an example, second data compressor 34 employs a self-relating method, an genetic algorithm method, or both, as described above, to compress the seventy-two (72) vector feature chart to a forty-eight (48) vector feature chart.

Referring to FIG. 3, second feature matching device 36 of the system then matches the data in a feature chart or feature data with a second feature module and generates a matching result. In one embodiment, second feature matching device 36 receives feature data that has been further compressed by second data compressor 34. Alternatively, second feature matching device 36 can receive a feature data that contains an uncompressed feature chart generated by first data compressor 32.

In one embodiment, the second feature module contains a second set of features that are partially or completely different from the first set of features in the first module, as discussed above. In addition, in one embodiment, the second feature module is provided or selected based on feature data, which identifies one or more categorizing features for a particular sub-array or for an image data array. In other words, the present invention provides a two-level matching in one embodiment, with the first level identifying categories of image data and the second level matching the image data to a set of features of in one or more selected categories.

For example, if the feature chart or feature data has features that are categorized as Arabic numerals, the second feature module is be a module of ten Arabic numerals, namely numbers of 0 to 9. The final matching result can identify one or more definite, pre-existing features, such as a Chinese character, an English character, an Arabic numeral, a predetermined image pattern, or a combination of characters or patterns. The final matching result, therefore, can identify the handwriting symbol contained in the image data array as representing a particular character or characters and the pattern recognition process is then completed. Depending on different applications, the matching results can identify two or more features for another matching operation by another matching device. Accordingly, a further matching operation or operations by a device or devices similar to second matching device 36 are added to provide a multiple-level matching.

In matching the data from feature charts or feature data with the second feature module, second feature matching device 36 uses an actual value module instead of a binary value module in one embodiment, as discussed above. In some cases, an actual value module describes the features in the module better and the use of it improves pattern recognition results.

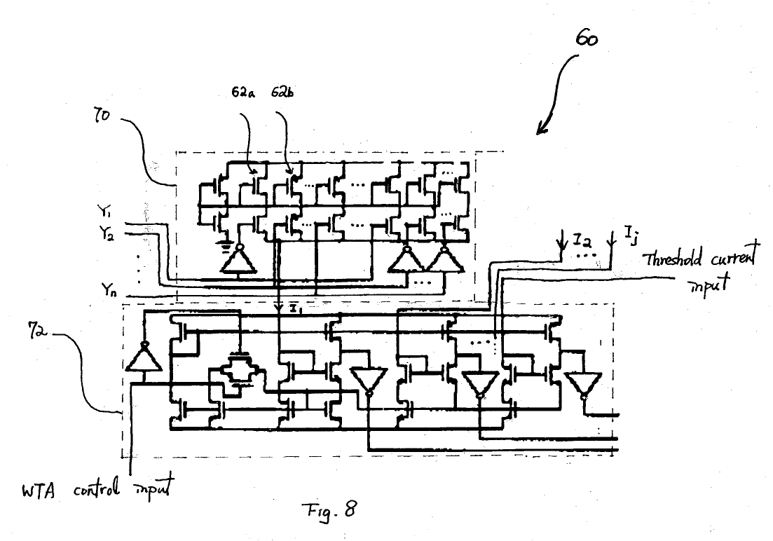

FIG. 8 illustrates an embodiment of implementing second feature matching device 36 with an actual value module, also known as a soft module. The circuit only shows one exemplary matching unit 60 for matching to a feature. Other features can employ a circuit similar to matching unit 60 to form the entire second

FIG. 8 shows feature matching circuit 70 and comparison circuit 72. In one embodiment, second feature matching device 36 includes a plurality of feature matching circuits similar to circuit 70 to compare the input feature chart with each of the features of the second module stored, and to generate a matching current representing the level of similarity. Second feature matching device 36 also includes comparison circuit 72 to compare the currents generated by all of the feature matching circuits.

In the second feature matching device, one of the current mirrors is selected as a reference current mirror to represent a reference level “1”. In one embodiment, other current mirror values are determined by the ratio of widths of the transistors, because the lengths of all transistors are the same. For example, if a template element is ‘0’, the left branch 62a, which has an inverter, can be removed. Also, if a template element is ‘1’, the right branch 62b, which has no inverter, can be removed.

Feature matching circuit 70 receives a feature chart through the input terminals Y1 through Yn and outputs a matching current I₁ to comparison circuit 72. The matching currents generated by other matching circuits, I₂ through Iⱼ, are sent to comparison circuit 72 so it identifies the greatest current or currents in a matching result. As discussed above, input inverters are used to identify whether a stored feature in a particular pixel (or neuron) has an “off” status. Matching circuit 70 as FINNEGAN shown uses PMOS transistors in one embodiment. Accordingly, the insertion of an inverter signifies that the particular pixel for that feature is “off” so that the presence of an “off” signal, which matches better with an “off” pixel of a feature, will increase the current I₁.

Comparison circuit 72 uses a controllable WTA circuit in one embodiment and receives a control signal from a WTA control input terminal. Based on the control signal, comparison circuit 72 becomes a 1-WTA circuit or a 2-WTA circuit. The optional 2-WTA operations enable the system to identify the two greatest currents for another level of matching or further identification. In other words, this option allows the implementation of multiple levels of matching. In addition, a threshold current input is sent to comparison circuit 72 through a threshold current input terminal to adjust the operation of the circuit and fine-tune the resolution, reliability, and accuracy of the circuit.

As discussed above, the present invention provides a system for processing an image data array for pattern recognition. The system provides a two-level feature matching and can be modified to enable multi-level feature matching of more than two levels. In addition, the system can be implemented with integrated circuit chip or chips, such as a chip using the VLSI technology, to provide the devices and circuits of various embodiments described above.

Alternatively, the system can be implemented with a computer or a processor accompanied by appropriate software, such as a computer-readable medium containing instructions that cause the processor to execute the operations discussed above. In addition, the system can be implemented with a processor and an E²PROM that contains instructions and other data. The use of an E²PROM provides flexibility in updating and altering the instructions and feature characteristics without having to replace a processor chip. As discussed above, the E²PROM is couple with a processor and control the processor's operations based on the data stored in the E²PROM. Therefore, if the data in an E²PROM is outdated or unsuitable for particular applications, the data are updated or modified to fine-tune matching operations to satisfy different requirements.

It will be apparent to those skilled in the art that various modifications and variations can be made in the disclosed device and method without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pattern recognition device for processing an array containing image data, the device comprising:
a first feature matching device for matching the image data with a first feature module to generate feature information, wherein the first feature module comprises a first set of categorizing features and the feature information identifies at least one matching categorizing feature;
a first data compressor for compressing the feature information to generate a feature chart for the array;
a second feature matching device for receiving feature data created based on the feature chart and matching the feature data with a second feature module to generate a matching result, wherein the second feature module comprises a second set of features that are provided based on the feature data.

2. The device of claim 1, wherein the array comprises at least a portion of a handwritten symbol.

3. The device of claim 1, wherein the matching categorizing feature identifies at least one category of features that the image data belongs to.

4. The device of claim 1, wherein the array comprises a sub-array of a larger image data array.

5. The device of claim 4, further comprising an array divider for dividing the larger image data array into at least two sub-arrays.

6. The device of claim 5, wherein each of the sub-arrays divided from the larger image data array comprises an overlapping area with at least one neighboring sub-array.

7. The device of claim 1, wherein the first feature matching device scans the array with at least two scanning windows that are smaller than the array and the first feature matching device matches image data within each scanning window with the first feature module to generate feature information for each scanning window.

8. The device of claim 7, wherein the feature information generated by the first feature matching device identifies at least one matching categorizing feature for each scanning window.

9. The device of claim 7, wherein the feature information generated by the first feature matching device identifies two matching categorizing features for each scanning window.

10. The device of claim 1, wherein the second feature matching device provides the second set of features based on the matching categorizing feature identified by the first feature matching device.

11. The device of claim 1, wherein the first feature matching device provides a matching adjustment factor for each of the categorizing features of the first feature module based on a level of difficulty in matching images to a particular categorizing feature.

12. The device of claim 11, wherein the matching adjustment factor for each of the categorizing features comprises a threshold value based on the level of difficulty in matching the images to the particular categorizing feature.

13. The device of claim 1, wherein the first feature information compressor compresses the feature information by combining information related to same or similar categorizing features to generate the feature chart.

14. A feature matching device for generating matching information by matching image data to a set of features, comprising:
a matching rate computation circuit for computing a matching rate between the image data and each feature of the set of features by generating a matching current for each feature, the matching rate computation circuit generating a plurality of matching currents, wherein a sub-circuit for matching the image data to a feature comprises a current mirror that contributes to a matching current; and
a matching rate comparison circuit for comparing the plurality of matching currents to identify the greatest matching current of the plurality of matching currents.

15. The device of claim 14, wherein the matching rate comparison circuit also identifies two greatest matching currents of the plurality of matching currents.

16. The device of claim 14, wherein the current mirror of the sub-circuit comprises a bias circuit for adjusting a current of the current mirror.

17. The device of claim 16, wherein the current mirror further comprises a bias circuit comprising
a first bias transistor having a first end of the source and drain terminals thereof connecting to a voltage source and having a second end of the source and drain terminals thereof connecting to the gate thereof and a bias output terminal; and
a second bias transistor having a first end of the source and drain terminals thereof connecting to the gate thereof and the bias output terminal and having a second end of the source and drain terminals thereof connecting to a ground terminal.

18. The device of claim 17, wherein the first bias transistor is a NMOS transistor and the second bias transistor is a PMOS transistor.

19. The device of claim 16, wherein the current mirror further comprises a first transistor having a first end of the source and drain terminals thereof connecting to a voltage source, a second end of the source and drain terminals thereof connecting to a matching current output terminal, and a gate thereof connecting to a bias output terminal.

20. The device of claim 19, wherein the current mirror further comprises a second transistor having a first end of the source and drain terminals thereof connecting to the voltage source, a second end of the source and drain terminals thereof connecting to the matching current output terminal, and a gate thereof connecting to the bias output terminal.

21. The device of claim 20, wherein the first and second transistors are NMOS transistors.

22. The device of claim 14, wherein the set of features comprise a plurality of categorizing features for the feature matching device to identify at least one matching category for the image data.

23. A feature information compressor for compressing feature information of an array containing image data by combining same or similar categorizing features within the feature information to generate feature charts.

24. A method of processing an array of image data for a pattern recognition, comprising:
providing a first feature module containing a first set of categorizing features;
matching the image data with the first feature module to generate feature information, wherein the feature information identifies a matching categorizing feature;
compressing the feature information to generate a feature chart for the array;
providing a second feature module containing a second set of modules provided based a feature data created based on the feature chart; and
matching the feature data with the second feature module to generate a matching result.

25. The method of claim 24, wherein the array comprises at least a portion of a handwritten symbol.

26. The method of claim 24, wherein the array comprises a sub-array of a larger image data array.

27. The method of claim 26, further comprising dividing the larger image data array into at least two sub-arrays.

28. The method of claim 27, wherein each of the sub-arrays divided from the larger image data array comprises an overlapping area with at least one neighboring sub-array.

29. The method of claim 24, wherein the matching categorizing feature comprises a feature that identifies at least one category of features that the image data belongs to.

30. The method of claim 24, wherein matching the image data with the first feature module comprises scanning the array with at least two scanning windows and matching image data within each scanning window with the first feature module to generate feature information for each scanning window.

31. The method of claim 24, wherein matching the image data with the first feature module comprises generating the feature information to identify at least two matching categorizing features.

32. The method of claim 24, further comprising providing a matching adjustment factor for each of the categorizing features of the first feature module based on a level of difficulty in matching images to a particular categorizing feature.

33. The method of claim 32, wherein the matching adjustment factor for each of the categorizing features comprises a threshold value based on the level of difficulty in matching the image to the particular categorizing feature.

34. The method of claim 24, wherein compressing the feature information to generate the feature chart comprises combining information related to same or similar categorizing features in the feature information.

35. The method of claim 24, further comprising compressing the feature chart to generate the feature data.

36. The method of claim 24, wherein providing the second feature module comprises providing the second set of features based on the matching categorizing feature identified in the feature information.

37. The method of claim 24, wherein the method is implemented with a computer-readable medium and a processor.

38. The method of claim 24, wherein the method is implemented with an E²PROM and a processor.

39. A pattern recognition method, comprising:
providing an array of image data for a pattern recognition;
providing a first feature module containing a first set of categorizing features;
matching the image data with the first feature module to generate feature information, wherein the feature information identifies a matching categorizing feature;
compressing the feature information to generate a feature chart for the array;
compressing the feature chart to generate feature data for the array;
providing a second feature module containing a second set of modules provided based the feature data; and
matching the feature data with the second feature module to generate a matching result.

40. The method of claim 39, wherein the array comprises a sub-array of sub-arrays divided from a larger image data array and each of the sub-arrays comprises an overlapping area with at least one neighboring sub-array.

41. The method of claim 39, wherein matching the image data with the first feature module comprises generating the feature information to identify at least two matching categorizing features.

42. The method of claim 39, further comprising providing a matching adjustment factor for each of the categorizing features of the first feature module based on a level of difficulty in matching images to a particular categorizing feature.

43. The method of claim 39, wherein providing the second feature module comprises providing the second set of features based on the matching categorizing feature identified in the feature information.

44. A computer-readable medium comprising instructions to cause a computer to execute the steps of:
providing a first feature module containing a first set of categorizing features;
matching the image data with the first feature module to generate feature information, wherein the feature information identifies a matching categorizing feature;
compressing the feature information to generate a feature chart for the array;
providing a second feature module containing a second set of modules provided based a feature data created based on the feature chart; and
matching the feature data with the second feature module to generate a matching result.

45. The computer-readable medium of claim 44, wherein the array comprises a sub-array of sub-arrays divided from a larger image data array and each of the sub-arrays comprises an overlapping area with at least one neighboring sub-array.

46. The computer-readable medium of claim 44, further comprising instructions to cause the computer to execute the step of providing a matching adjustment factor for each of the categorizing features of the first feature module based on a level of difficulty in matching images to a particular categorizing feature.

47. The computer-readable medium of claim 44, further comprising instructions to cause the computer to execute the step of compressing the feature chart to generate the feature data.

48. The computer-readable medium of claim 44, wherein providing the second feature module comprises providing the second set of features based on the matching categorizing feature identified in the feature information.
